(19) United States
(12) Patent Application Publication
(10) Pub. No.: US 2005/0079338 A1
(43) Pub. Date: Apr. 14, 2005

(54) Method of heat treatment, method for forming wiring pattern, method for manufacturing electro-optic device, and electro-optic device and electronic apparatus

(75) Inventor: Naoyuki Toyoda, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/922,098

(22) Filed: Aug. 20, 2004

(30) Foreign Application Priority Data
Aug. 22, 2003 (JP) 2003-299082

(51) Int. Cl. B32B 3/26

(52) U.S. Cl. 428/304.4

(57) ABSTRACT

To provide a heat treatment method to efficiently heat-treat an object without depending on the material of the object, a heat treatment layer includes a light-to-heat conversion layer to convert light energy into thermal energy and a base material. The heat treatment sheet is opposed to an object and exposed to light. Thus, the object is heat-treated by thermal energy generated from the light-to-heat conversion layer.

### BACKGROUND OF THE INVENTION

1. Field of Invention

Exemplary aspects of the present invention relate to a method of heat treatment, a method to form a wiring pattern, a method to manufacture an electro-optic device, and an electro-optic device and an electronic apparatus.

2. Description of Related Art

A related art conductive thin-film deposited on a substrate is often modified by heat treatment. Japanese Unexamined Patent Application Publication No. 5-21387 discloses a technique of laser annealing to modify a metallic thin film formed on a substrate by exposure to laser light.

### SUMMARY OF THE INVENTION

A functional liquid containing a conductive material, applied onto a substrate is heat-treated (fired) to develop conductivity. However, such heat treatment must be performed at temperatures of at least 300° C. for 30 minutes or more. Thus, the heat treatment takes a long time and prevents increase in productivity. In addition, if a non-heat resistant material, such as plastic, is used in the substrate, heat treatment performed at high temperature for a long time deforms the substrate or causes other disadvantages.

In view of the foregoing and/or other disadvantages, exemplary aspects of the present invention provide a method to efficiently heat-treat an object (substrate) without depending on the material of the object. Exemplary aspects of the present invention also provide methods to form a wiring pattern and to manufacturing an electro-optic device through the heat treatment method, and to provide an electro-optic device and an electronic apparatus.

In order to address or overcome the foregoing and/or disadvantages, a heat treatment method is provided in which an object is heat-treated with a light-to-heat converting material to convert light energy into thermal energy, by exposing a base material having the light-to-heat converting material to light with the base material opposed to the object. Since the base material includes the light-to-heat converting material, the light energy of emitted light can be effectively converted into thermal energy. Consequently, a sufficient amount of thermal energy is applied to the object to heat-treat it. The emitted light irradiates the light-to-heat converting material to increase temperature instantaneously. Accordingly, the object can be heat-treated in a short time. In addition, since the thermal energy is instantaneously applied to the object, the object (substrate) is not affected even if it contains a non-heat resistant material, such as plastic.

The light may be emitted to the base material with the object in close contact with the base material. Consequently, the thermal energy generated from the light-to-heat converting material of the base material can be efficiently applied to the object.

In the heat treatment method of an exemplary aspect of the present invention, a light-to-heat conversion layer containing the light-to-heat converting material may be provided on the base material independently from the base material, or the base material may contains the light-to-heat converting material. Either structure can apply heat energy generated by the light-to-heat converting material to the object to heat-treat the object.

If the light-to-heat conversion layer containing the light-to-heat converting material is provided independently from the base material, light may be emitted to the base material with the light-to-heat conversion layer opposed to the object. The light may be emitted with the light-to-heat conversion layer in close contact with the object. Thus, the thermal energy generated from the light-to-heat conversion layer can be efficiently applied to the object.

In an exemplary aspect of the present invention, the heat treatment includes at least one of drying and firing. Specifically, the light-to-heat converting material can apply a sufficient amount of thermal energy to dry or fire the object.

In a heat treatment method according to an exemplary aspect of the present invention, the object may include a conductive material to be heat-treated. Thus, a material layer containing the conductive material is, for example, fired to develop conductivity. If the material layer contains an organic EL (electroluminescent) display material, liquid crystal display material, or plasma display material, the heat treatment method can be applied to a drying step or a firing step of the process to manufacture these display devices.

In the heat treatment method of an exemplary aspect of the present invention, the light may be laser light having a wavelength according to the light-to-heat converting material. Consequently, light energy emitted to the light-to-heat converting material can be efficiently converted into thermal energy.

A method to form a wiring pattern of an exemplary aspect of the present invention includes heat-treating a conductive material layer provided on an object by the foregoing heat treatment method. Thus, the conductive material layer is fired to develop conductivity, thereby forming a wiring pattern in a short time, without depending on the material of the object.

A method to manufacture an electro-optic device of an exemplary aspect of the present invention includes heat-treating a functional material layer provided on an object by the foregoing heat treatment method. By applying the heat treatment method of an exemplary aspect of the present invention to a heat treatment step of a manufacturing process of an electro-optic device, the functional material layer can be heat-treated in a short time without depending on the material of the object. Consequently, productivity can be increased.

An electro-optic device of an exemplary aspect of the present invention includes a wiring pattern formed by the foregoing wiring pattern forming method. Another electro-optic device of an exemplary aspect of the present invention is manufactured by the method to manufacture an electro-optic device. An electronic apparatus of an exemplary aspect of the present invention includes the foregoing electro-optic device. According to an exemplary aspect of the present invention, electro-optic devices and electronic apparatus including the electro-optic devices can be manufactured with high productivity, and the resulting devices and apparatus can exhibit desired performance.

Such electro-optic devices include liquid crystal display devices, organic EL (electroluminescent) display devices, and plasma display devices.

To provide the material layer (conductive material layer, functional material layer) on the object, a liquid discharge technique may be applied in which droplets of a functional liquid are discharged to deposit onto the object (substrate). The liquid discharge technique is realized by use of a liquid discharge apparatus including a liquid discharge head. Such liquid discharge apparatus include an ink jet apparatus having an ink jet head. The ink jet head of the ink jet apparatus can quantitatively discharge droplets of a liquid material, including a functional liquid. For example, it can quantitatively and intermittently discharge 1 to 300 ng of liquid material for a dot. The liquid discharge apparatus may be a dispenser.

The liquid material is a medium having such a viscosity as to be discharged (dripped) from a discharge nozzle of the discharge head of the discharge apparatus. It is irrelevant whether the liquid material is water-based or oil-based. It suffices that the liquid material has such a flowability (viscosity) as to be discharged from the discharge nozzle. Even if solids are contained, it suffices that the liquid material is fluid as a whole. The material contained in the liquid material may be prepared by being heated to a temperature of the melting point or more, or being dispersed as particles in a solvent. The liquid materially may contain a dye or a pigment in addition to the solvent.

The functional liquid is a liquid material containing a functional material, and is deposited on a substrate to function in a desired manner. Exemplary functional materials include liquid crystal display materials to form liquid crystal display devices, including color filters, organic EL (electroluminescent) display materials to form organic EL display devices, plasma display materials to form plasma display devices, and wiring pattern materials to form wiring patterns for applying power, including metals.

### BRIEF DESCRIPTION OF THE DRAWINGS

FIG. 1 is a schematic of the general structure of a heat treatment apparatus used in a heat treatment method according to an exemplary embodiment of the present invention;

FIGS. 2(a)-2(c) are schematics of a heat treatment method according to an exemplary embodiment of the present invention;

FIG. 3 is a schematic of a discharge head used to form a wiring pattern according to an exemplary aspect of the present invention;

FIG. 4 is a flow diagram of a procedure to form a wiring pattern according to an exemplary embodiment of the present invention;

FIGS. 5(a)-5(d) are schematics of a method to form a wiring pattern according to an exemplary embodiment of the present invention;

FIGS. 6(a)-6(h) are schematics of a method to form a wiring pattern according to an exemplary embodiment of the present invention;

FIG. 7 is a schematic showing heat treatment of a conductive material layer by a heat treatment method of an exemplary embodiment the present invention;

FIG. 8 is a schematic of a plasma display being an electro-optic device including a wiring pattern formed by a wiring pattern forming method of an exemplary aspect of the present invention;

FIGS. 9(a)-9(f) are schematics showing a process to manufacture a color filter of a liquid crystal display device, according to a method to manufacture an electro-optic device of an exemplary aspect of the present invention;

FIG. 10 is a schematic showing heat treatment of a color filter material by a heat treatment method of an exemplary aspect of the present invention;

FIGS. 11(a)-11(c) are schematics showing a process to manufacture an organic EL display device, according to a method to manufacture an electro-optic device of an exemplary aspect the present invention;

FIGS. 12(a)-12(c) are schematics showing a process to manufacture an organic EL display device, according to a method to manufacture an electro-optic device of an exemplary aspect the present invention;

FIGS. 13(a)-13(c) are schematics showing a process to manufacture an organic EL display device, according to a method to manufacture an electro-optic device of an exemplary aspect of the present invention;

FIG. 14 is a schematic showing heat treatment of an organic EL element by a heat treatment method of an exemplary aspect the present invention;

FIGS. 15(a)-15(c) are representations of electronic apparatus including an electro-optic device of an exemplary aspect the present invention; and

FIGS. 16(a)-16(c) are schematics showing a process to form microlenses.

### DETAILED DESCRIPTION OF EXEMPLARY EMBODIMENTS

Method of Heat Treatment

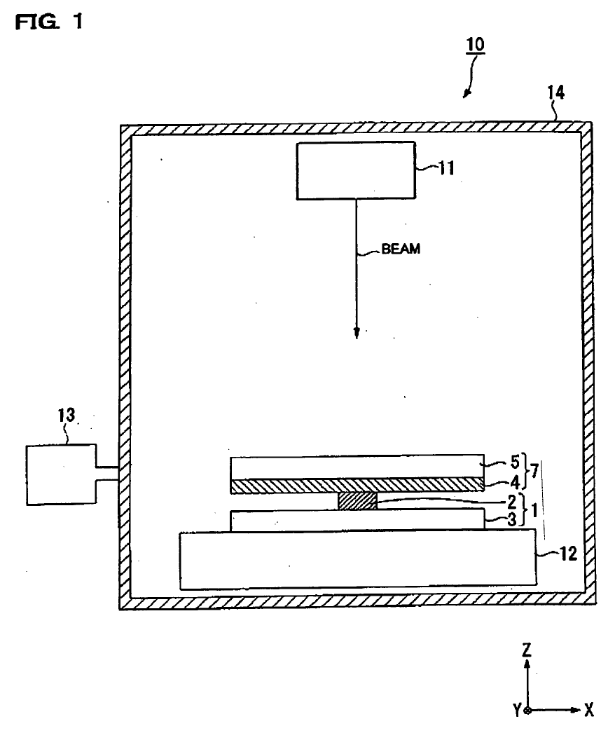

A method of heat treatment will now be described with reference to drawings. FIG. 1 shows a schematic of a heat treatment apparatus used in the heat treatment method according to an exemplary embodiment of the present invention. In FIG. 1, the heat treatment apparatus 10 includes a laser light source 11 to emit a laser beam having a predetermined wavelength and a stage 12 to support an object 1. The object 1 includes a substrate 3 and a material layer 2 provided on the upper surface of the substrate 3. The laser light source 11 and the stage 12 to support the object 1 are placed in a chamber 14. The chamber 14 is joined with a suction unit 13 to draw gas from the chamber 14. In the present exemplary embodiment, a near-infrared semiconductor laser (wavelength: 830 nm) is used as the laser light source 11.

For the following description, a specific direction in a horizontal plane is defined as the X-axis direction; the direction perpendicular to the X-axis direction in the horizontal plane, Y-axis direction; the direction (vertical direction) perpendicular to the X-axis and Y-axis directions, the Z-axis direction.

The object 1 is in close contact with a heat treatment sheet 7. The heat treatment sheet 7 includes a base material 5 and a light-to-heat conversion layer 4 provided on the base material 5. The light-to-heat conversion layer 4 is provided independently from the base material 5. The light-to-heat conversion layer 4 underlies the base material 5, in FIG. 1.

The stage 12 is provided in such a manner as to be movable in the X-axis and Y-axis directions, supporting the object 1 and the heat treatment sheet 7 in close contact with the object 1. The stage 12 is also movable in the Z-axis direction. Here, an optical system, not shown in the figure, is disposed between the light source 11 and the heat treatment sheet 7 supported by the stage 12. The position of the heat treatment sheet 7 (and the object 1) with respect to the focus of the optical system can be adjusted by moving the stage 12 supporting the object 1 and the heat treatment sheet 7 in the Z-axis direction. The light beam emitted from the light source 11 is applied to the heat treatment sheet 7 (base material 5) supported by the stage 12.

The base material 5 is transparent to the laser beam, and may be, for example, a glass substrate or a transparent macromolecular material. Exemplary transparent macromolecular materials include polyester, such as poly(ethylene terephthalate), polyacrylic resin, polyepoxy resin, polyethylene, polystyrene, polycarbonate, polysulfone, and polyimide. A transparent macromolecular base material 5 may have a thickness in the range of 10 to 500 μm. Such a thickness allows the base material 5 to be formed in a strip form. The strip-like base material 5 can be wound into a roll, and is thus held by, for example, a rotating drum to be carried (transferred).

In the present exemplary embodiment, the base material 5 is supported by the stage 12 which translationally moves in the X and Y direction. If the base material 5 is held by the rotating drum, however, the rotating drum can move in the horizontally translational direction (scanning direction, X direction), the rotating direction (Y direction), and the vertical direction (Z direction).

The light-to-heat conversion layer 4 contains a light-to-heat converting material to convert light energy into thermal energy. For the formation of the photothermal convention layer 4, any suitable light-to-heat converting material may be used as long as it can efficiently convert laser light into heat. For example, the light-to-heat conversion layer 4 may be a metal layer including aluminum or its oxide and/or sulfide, or a macromolecular organic layer containing carbon black, graphite, or an infrared absorbing pigment. Exemplary infrared absorbing pigments include anthraquinone dyes, dithiol nickel complexes, cyanine dyes, azo cobalt complexes, diimmonium dyes, squaleliums, phthalocyanines, and naphthalocyanines. The light-to-heat converting material may be dissolved or dispersed in a resin acting as a binder, such as epoxy resin, and applied onto the base material 5. In this instance, the epoxy resin serves as a curing agent, and curing the epoxy resin allows the light-to-heat conversion layer 4 to fix onto the base material 5. The light-to-heat converting material may also be deposited on the base material 5 without being dissolved or dispersed in the binder.

If the light-to-heat conversion layer 4 is the above-mentioned metal layer, it may be deposited on the base material 5 by vacuum deposition, electron beam vapor deposition, or sputtering. If the light-to-heat conversion layer 4 is the above-mentioned organic layer, it may be deposited on the base material 5 by film coating, such as extrusion coating, spin coating, gravure coating, reverse roll coating, rod coating, micro gravure coating, or knife coating. For coating the light-to-heat conversion layer 4, a functional liquid to form the light-to-heat conversion layer may be uniformly applied onto the base material 5 after static electricity built up on the surface of the base material 5 has been removed. Accordingly, any apparatus used for the coating processes preferably has a discharger.

The substrate 3 of the object 1 includes, for example, a glass pate, synthetic resin film, or semiconductor wafer. The material layer 2 is formed of a functional liquid containing particles of a metal, such as silver, in the present exemplary embodiment.

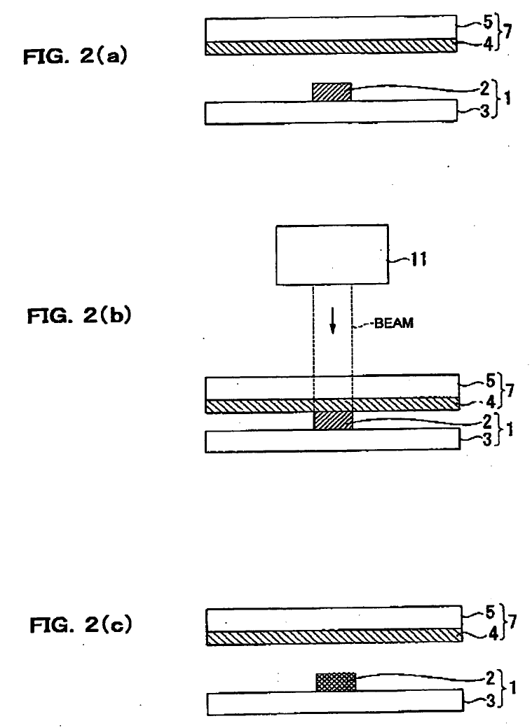

Turning to FIG. 2, the procedure of the heat treatment will now be described. As shown in FIG. 2(a), the light-to-heat conversion layer 4 of the heat treatment sheet 7 is opposed to the material layer 2 of the object 1, and they are brought into close contact with each other. For close contact between the light-to-heat conversion layer 4 and the material layer 2, the chamber 14 is evacuated by operating the suction unit 13 (see FIG. 1) after opposing the light-to-heat conversion layer 4 to the material layer 2. Consequently, the pressure of the space between the light-to-heat conversion layer 4 and the material layer 2 (object 1) is reduced to be a negative pressure. Thus, the light-to-heat conversion layer 4 and the material layer 2 come into close contact with each other. Then, a laser beam having a predetermined diameter is emitted from above the upper surface of the heat treatment sheet 7 (base material 5), as shown in FIG. 2(b). By emitting the laser beam, the base material 5 and the light-to-heat conversion layer 4, which lie in the region to be irradiated with the laser beam, are heated. The light-to-heat conversion layer 4 converts the light energy of the emitted laser beam into thermal energy which is applied to the material layer 2. The material layer 2 is heated (fired) by the application of the thermal energy. Thus, the material layer 2 of the object is heat-treated with the light-to-heat conversion layer 4.

After heating the material layer 2, the operation of the suction unit 13 is stopped to release the reduced pressure (negative pressure) in the chamber. Thus, the heat treatment layer 7 becomes separable from the object 1, as shown in FIG. 2(c).

As described above, the light-to-heat conversion layer 4 provided on the base material 5 efficiently converts the light energy of emitted light into thermal energy, so that a sufficient amount of thermal energy is applied to the object 1 (material layer 2) to heat-treat it. In the present exemplary embodiment, light is emitted to irradiate the light-to-heat conversion layer 4 through the base material 5 to increase temperature instantaneously. Accordingly, the object 1 (material layer 2) can be heat-treated in a short time. In addition, since the thermal energy is instantaneously applied to the object 1 (material layer 2), the substrate 3 of the object 1 is not affected even if it contains a non-heat resistant material, such as plastic. Furthermore, the light-to-heat conversion layer 4 helps near-infrared laser light, as well as electron beam or ultraviolet light, to apply a sufficient amount thermal energy to the material layer 2 to heat-treat the object 1 (material layer 2). Thus, the range of choices in irradiation equipment extends, and the object 1 (material layer 2) is heat-treated (fired) with a sufficient amount of thermal energy by use of the light-to-heat conversion layer 4 of the heat treatment sheet 7, without using an expensive large-scale irradiation equipment.

By use of the light-to-heat converting material, annealing with laser light can be applied even if the object 1 includes a material incapable of absorbing light energy (laser light energy) or converting the light energy into thermal energy. For example, exposure to infrared laser light allows a silver ink to dry (to remove the solvent), but not to develop conductivity. Also, exposure of the silver ink to infrared laser light causes ablation, consequently preventing film formation. This is because the silver ink does not absorb light energy well. However, use of the light-to-heat converting material, as in exemplary aspects of the present invention, makes it possible to apply light annealing to materials incapable of absorbing light energy, such as the silver ink. Also, since there is a limitation in choices of materials capable of absorbing long-wavelength laser light, such as infrared light, it is effective to use the light-to-heat converting material. For example, use of carbon black as the light-to-heat converting material allows the generation of high temperatures of several hundred degrees centigrade or more (for example, at least 300° C. or at least 500° C.), so that the silver ink, which can be fired at a temperature of at least 300° C., can be fired.

In the present exemplary embodiment, light is emitted with the heat treatment sheet 7 in close contact with the object 1. However, thermal energy generated in the light-to-heat conversion layer 4 may be applied to the object 1 (material layer 2) opposed to the light-to-heat conversion layer 4 with a small gap therebetween.

While the material layer 2 on the substrate 3, in FIG. 2, has substantially the same size as the diameter of the laser beam, the material layer 2 may have a larger size than the diameter of the laser beam, for example, spreading over the entire surface of the substrate 3. In this instance, by exposing a predetermined region of the heat treatment sheet 7 (base material 5) to light, the material layer 2 provided having a larger size than the laser beam diameter can be patterned according to the region subjected to exposure, and part of the material layer 2 corresponding to the region can be heat-treated (fired).

For heat-treating (firing) a predetermined region of the material layer 2, the heat treatment sheet 7 (base material 5) may be exposed to light through a mask having a predetermined pattern. Thus, a fine pattern with a size smaller than the diameter of emitted laser beam is formed in the heat-treated region. Exposure to a laser beam may be performed while the stage 12 is moved in the X and Y directions to move the heat treatment sheet 7 and the object 1 with respect to the laser beam. Specifically, the pattern may be formed in the heat-treated region by relatively moving emitted light (laser beam) and the heat treatment sheet 7 and object 1. Thus, the preparing of a mask can be omitted.

In the present exemplary embodiment, the light-to-heat conversion layer 4 is provided at the surface opposing the material layer 2 of the heat treatment layer 7, specifically, on the lower surface of the base material 5. But it may be provided at the surface not opposing the material layer 2 of the heat treatment layer 7, specifically, on the upper surface of the base material 5. The light-to-heat conversion layer 4 provided in such a structure can also generate thermal energy and apply it to the material layer 2 through the base material 5. The light-to-heat conversion layer 4 may be provided on both the upper and lower surfaces of the base material 5.

While, in the present exemplary embodiment, the light-to-heat converting material is provided as a layer (the light-to-heat conversion layer 4) independent from the base material 5, the base material 5 may contain the light-to-heat converting material. Even in such a structure, light energy of emitted laser light can be converted into thermal energy, and the thermal energy is applied to the object 1 (material layer 2). An additional light-to-heat conversion layer 4 may be independently provided on the base material 5 containing the light-to-heat converting material.

While, in the present exemplary embodiment, light is emitted from the heat treatment sheet 7 side with the heat treatment layer 7 in close contact with the object 1, the light may be emitted from the object 1 side. In this instance, the substrate 3 and the material layer 2 of the object 1 each include a transparent material, and light irradiates the light-to-heat conversion layer 4 through the substrate 3 and the material layer 2.

The light source 11 may be a mercury lamp, a halogen lamp, a xenon lamp, or a flash lamp, instead of the infrared semiconductor laser. In addition, any general-purpose laser may be used, including ultraviolet laser.

The wavelength of the light may be selected depending on the light-to-heat converting material if the light-to-heat conversion layer 4 is provided. The wavelength band of light capable of being efficiently absorbed depends on the light-to-heat converting material. By emitting light having a wavelength according to the light-to-heat converting material, light energy is efficiently converted into thermal energy. In other words, the light-to-heat converting material may be selected depending on emitted light. In the present exemplary embodiment, an infrared semiconductor laser (wavelength: 830 nm) is used as the laser light source. Accordingly, a material capable of absorbing light in a wavelength band from infrared to visible light may be used as the light-to-heat converting material.

An interlayer may be provided between the base material 5 and the light-to-heat conversion layer 4 or on the surface of the light-to-heat conversion layer 4 to uniformize the light-to-heat conversion effect of the light-to-heat conversion layer 4. For the interlayer, a resin carrying out such an objective is used. For the formation of the interlayer, a predetermined resin composition is applied onto the surface of the light-to-heat conversion layer 4 by a known coating method, such as spin coating, gravure coating, or dye coating, and dried. The light energy of an emitted laser beam is converted into thermal energy by the function of the light-to-heat conversion layer 4, and the thermal energy is uniformized by the function of the interlayer. Thus, the thermal energy can be uniformly applied to the region irradiated with the light of the material layer 2 (object 1).

### EXAMPLE

A polycarbonate sheet with a thickness of about 0.2 mm was used as the base material 5 of the heat treatment sheet 7. The sheet was coated with a thermosetting epoxy resin containing carbon black at a thickness of about 2 μm. The epoxy resin was cured into a light-to-heat conversion layer 4. A silver ink material layer was deposited on a poly(ethylene terephthalate) (PET) film to prepare an object 1 by a liquid discharge technique. The film or the object was held by a rotating drum in such a manner that the surface having the material layer faces outward, and the heat treatment sheet was wound over the film in such a manner that the surface having the light-to-heat conversion layer faces inward. Thus, the light-to-heat conversion layer was brought into close contact with the film. While the rotation drum was rotated at a speed of 50 rpm, a laser beam having a wavelength of 830 nm was emitted twice onto the sheet from a 14 W infrared semiconductor laser. The silver ink took on a silver color, and exhibited a resistance of 30 Ω/cm. Thus, it was shown that the silver ink became conductive.

Method to Form a Wiring Pattern

A method to form a wiring pattern including a heat treatment according to an exemplary aspect of the present invention will now be described. In this exemplary embodiment, a material to form a wiring pattern is provided on the substrate 3 of the object 1, and the wiring pattern material is heat-treated by the heat treatment method according to an exemplary aspect of the present invention. In order to provide the wiring pattern material on the substrate 3, a functional liquid containing the wiring pattern material is discharged by a liquid discharge technique (ink jetting). In the liquid discharge technique, droplets of the functional liquid containing the wiring pattern material is discharged onto the substrate 3 from a discharge heat 20 opposed to the substrate 3.

For discharging liquid, several techniques can be used, such as electrification control, pressure vibration, electrothermal conversion, electrostatic suction, and electromechanical conversion. In the electrification control, an electrification electrode applies electrical charge to a material, and the material is discharged from a discharge nozzle while the discharge direction of the material is controlled by a deflection electrode. In the pressure vibration, an ultra-high pressure of about 30 kg/cm² is applied to the material to be discharged to the nozzle tip side. When no control voltage is applied, the material goes straight to discharge from the discharge nozzle. When a control voltage applied, electrostatic repulsion occurs among the particles or molecules of the material to reduce the likelihood or prevent the material from discharging from the discharge nozzle. In the electrothermal conversion, the material is rapidly vaporized to generate bubbles with a heater placed in a room containing the material, and the pressure of the bubbles discharges the material from the room. In the electrostatic suction, a minute pressure is applied to a room containing the material to form a meniscus at the discharge nozzle. Maintaining this state, electrostatic suction is applied to draw the material. The electromechanical conversion involves the use of a piezoelectric element, which is deformed by a pulsed electrical signal. By the deformation of the piezoelectric element, pressure is applied to a room containing the material via a flexible material, thus extruding the material from the room to discharge from the discharge nozzle. In addition, other techniques may be applied, including the techniques of applying an electric field to vary the viscosity of fluid and of flicking the material by electrical discharge or spark. The liquid discharge technique does not waste the material and allows precise deposition of a predetermined amount of material in predetermined positions. A weight of a drop of the material discharged by the liquid discharge technique is, for example, in the rage of 1 to 300 ng. In the present exemplary embodiment, the electromechanical conversion (piezoelectric technique) is applied.

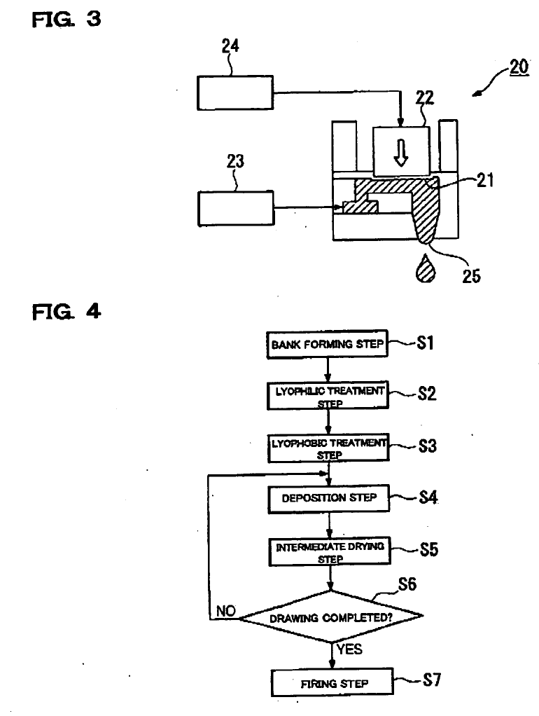

FIG. 3 shows a principle of the piezoelectric technique to discharge a functional liquid (liquid material).

In FIG. 3, the discharge head 20 includes a liquid chamber 21 containing the functional liquid (liquid material containing the wiring pattern material) and a piezoelectric element 22 adjacent to the liquid chamber 21. The functional material is fed to the liquid chamber 21 through a supply line 23 including a material tank containing the functional liquid. The piezoelectric element 22 is connected to a driving circuit 24. A voltage is applied to the piezoelectric element 22 through the driving circuit 24 to deform the piezoelectric element 22, thereby deforming the liquid chamber 21 to discharge the functional liquid from a discharge nozzle 25. In this case, by varying the value of applied voltage, the degree of deformation of the piezoelectric element 22 is controlled. Also, by varying the frequency of applied voltage, the speed of deformation of the piezoelectric element 22 is controlled. Since the piezoelectric discharge does not apply heat to the material, the composition of the material is not affected, advantageously.

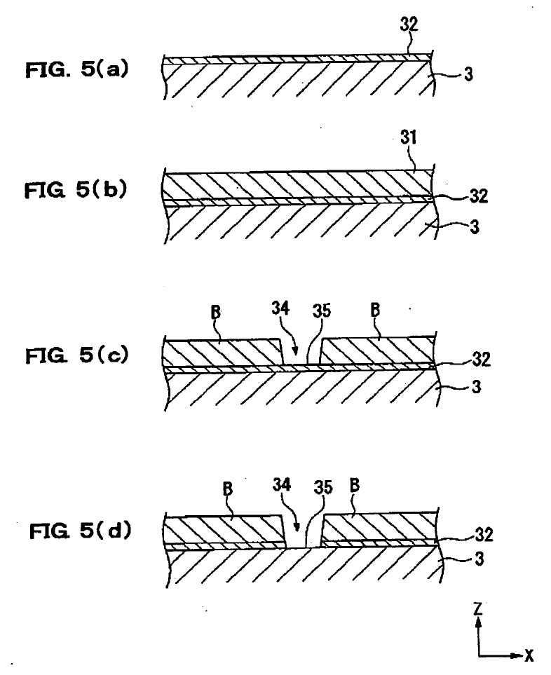

A procedure to form a wiring pattern will now be described. FIG. 4 is a schematic of the procedure to form the wiring pattern. The functional liquid to form the wiring pattern includes an organic silver compound dissolved (or dispersed) in diethylene glycol diethyl ether. In FIG. 4, the method to form the wiring pattern of an exemplary aspect of the present invention includes: a bank forming step (Step 1) of forming banks on a substrate onto which droplets of the functional liquid are deposited, according to the wiring pattern; the lyophilic treatment step (Step 2) of making lyophilic the bottom of recesses defined by the banks; the lyophobic treatment step (Step 3) of making the banks lyophobic; the deposition step (Step 4) of depositing the droplets of the functional liquid into the recesses between the banks to form (draw) a film pattern by the liquid discharge technique; the intermediate drying step (Step 5) including the sub step of heat-treating the functional liquid to remove at least a part of the liquid constituents of the functional material; and the firing step (Step 7) of firing the substrate having the predetermined patter. After the intermediate drying step, it is determined whether the drawing of the predetermined pattern has been completed (in Step 6). If the pattern formation has been completed, the firing step is performed; if the pattern formation has not yet been completed, the deposition step is performed.

Each step is performed as follows:

Bank Forming Step

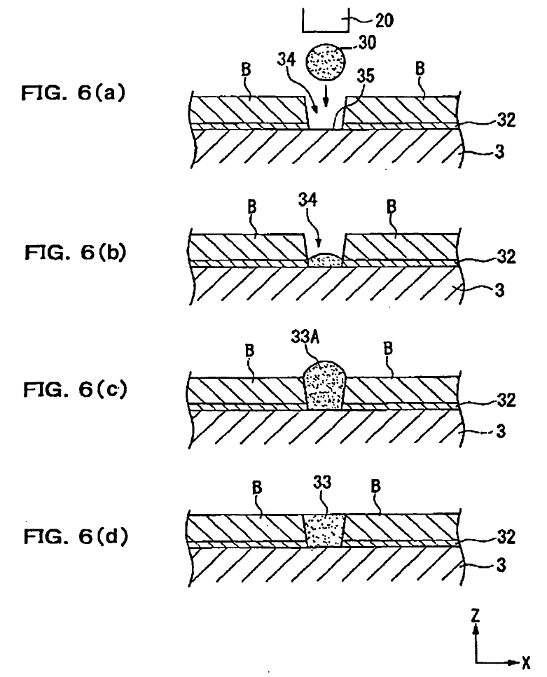

As shown in FIG. 5(a), the substrate 3 is subjected to HMDS treatment to modify the surface. In the HMDS treatment, vaporized hexamethyldisilazane ((CH₃)₃SiNHSi(CH₃)₃) is applied. Thus, a HMDS layer 32 is formed on the substrate 3, and serves as an adhesion layer to enhance the adhesion between the banks and the substrate 3. The banks serve as partitions to partition a predetermined region (wiring pattern-forming region) on the substrate 3. The banks are formed by photolithography, printing, or any other method. For example, in photolithography, an organic material 31 to form the banks is applied at a height equivalent to the height of the banks onto the HMDS layer 32 of the substrate 3 by predetermined coating technique, such as spin coating, spray coating, roll coating, dye coating, or dip coating, as shown in FIG. 5(b). Subsequently, a resist is further applied onto the organic material. Then, a mask is provided corresponding to the bank pattern (wiring pattern) and the resist is subjected to exposure and development to leave the resist in a shape corresponding to the bank pattern. Finally, the organic material 31 in regions other than the region underlying the resist is removed by etching. Alternatively, the banks may be composed of at least two layers including an inorganic lower layer and an organic upper layer. Thus, the banks B are formed to surround the regions in which the wiring pattern is to be formed, as shown in FIG. 5(c). The organic material to form the banks may be repellent to the functional liquid, or it may be an insulating organic material capable of being made repellent to the functional liquid by plasma treatment, as described later, and of being easily patterned by photolithography. For example, the organic material may be a macromolecular material, such as acrylic resin, polyimide resin, olefin resin, phenol resin, or melamine resin.

After the formation of the banks B on the substrate 3, hydrofluoric acid treatment is applied. For example, etching is performed with 2.5% hydrofluoric acid solution to remove the HMDS layer 32 between the banks B. In the hydrofluoric acid treatment, the banks B serve as a mask so that the organic HMDS layer 32 is removed from the bottoms 35 of the recesses 34 defined by the banks B. Thus, remaining HMDS is removed, as shown in FIG. 5(d).

Lyophilic Treatment Step

Then, the lyophilic treatment step is performed to make the bottom 35 of the recess 34 lyophilic. For the lyophilic treatment, ultraviolet (LV) light exposure, O₂ plasma treatment, or other treatment may be applied. The UV light exposure gives lyophilic properties by exposure to ultraviolet light; the O₂ plasma treatment uses oxygen as a reaction gas in an atmosphere of air. If the substrate includes glass, its surface is lyophilic to the functional liquid. The lyophilic properties of the surface (bottom 35) of the substrate 3 exposed between the banks B can be enhanced by applying the O₂ plasma treatment or UV exposure treatment.

The O₂ plasma treatment and the UV exposure treatment have the function of removing the HMDS constituting part of the residue at the bottom 35. Consequently, even if the organic residue (HMDS) at the bottom 35 between the banks B is not removed completely by hydrofluoric acid treatment, the O₂ plasma treatment or the UV exposure treatment removes the rest of the residue. Although, in the present exemplary embodiment, hydrofluoric acid treatment is performed as part of the removal of the residue, the hydrofluoric acid treatment is not necessary because the O₂ plasma treatment or the UV exposure treatment can completely remove the residue at the bottom 35 between the banks. In the present exemplary embodiment, either the O₂ plasma treatment or the UV exposure treatment is performed. However, these treatments may be performed in combination.

Lyophobic Treatment Step

Then, the banks are subjected to lyophobic treatment to make their surface lyophobic. For lyophobic treatment, plasma treatment (CF₄ plasma treatment) may be adopted in an atmosphere of air using carbon tetrafluoride (or tetrafluoromethane) as a reaction gas. Other fluorocarbon gases may be used as the reaction gas, instead of carbon tetrafluoride. By the lyophobic treatment, a fluorine group is introduced to the resin constituting the banks B to make the banks highly lyophobic. The above-described O₂ plasma lyophilic treatment may be performed before the formation of the banks B. However, since acrylic resin, polyimide resin, and other organic materials used for the banks B more easily become lyophobic (fluorinated) after being subjected to O₂ plasma treatment. The O₂ plasma treatment may be performed after the formation of the banks B.

The lyophobic treatment of the banks B affects the surface of the substrate 3 exposed between the banks, which has been subjected to lyophilic treatment, to some extent. However, since lyophobic treatment does not introduce the fluorine group into the substrate 3 if it is formed of glass or the like, the lyophilic properties, or wettability, of the substrate 3 are not substantially affected. The banks B may be formed of a lyophobic material (for example, a resin having a fluorine group) so that the lyophobic treatment can be omitted.

Deposition Step

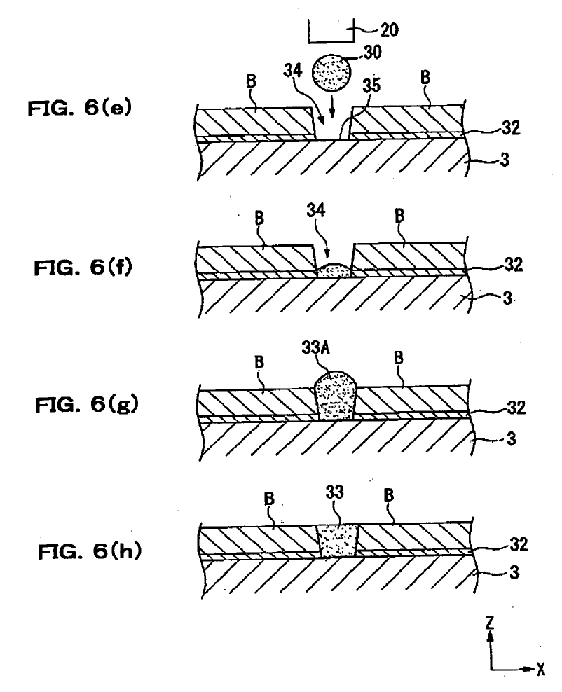

In the deposition step, a droplet 30 of the functional liquid containing a wiring pattern forming material is discharged from the liquid discharge head 20 of a liquid discharge apparatus to deposit the material in the recess 34 between the banks B, thereby forming a linear film pattern (wiring pattern) on the substrate 3, as shown in FIG. 6(e). In the present exemplary embodiment, the functional liquid includes an organic silver compound dispersed in diethylene glycol diethyl ether. The organic silver compound contains silver being a wiring pattern forming material. Since the region where the wiring pattern is to be formed, that is, the recess 34, is surrounded by the banks B, the likelihood that droplets spread outside the predetermined region is reduced or eliminated. Also, since the banks B are lyophobic, the surface of the banks B repels droplets undesirably discharged to the banks, and thereby the droplets flow into the recess 34 between the banks B. In addition, since the bottom 35 of the recess 34, where the surface of the substrate 3 is exposed, is lyophilic, the discharged droplets easily spread at the bottom 35, and thus the functional liquid can uniformly deposited in the predetermined region, as shown in FIG. 6(f).

Intermediate Drying Step

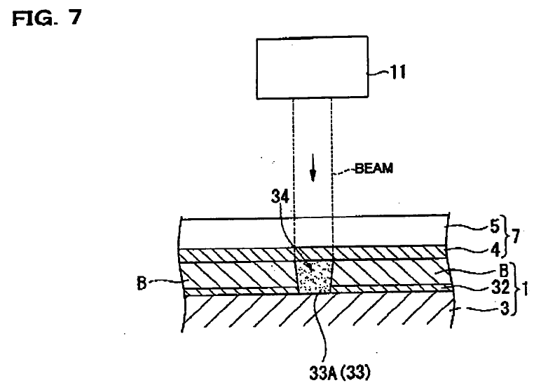

After discharging the droplets 30 onto the substrate 3, drying treatment is performed, if necessary, to remove the disperse medium and provide a thickness. The drying treatment is performed according to the heat treatment method of exemplary aspects of the present invention. Specifically, the banks B and the functional liquid in the recess 34 on the substrate 3, or the object, are brought into close contact with the heat treatment sheet 7, and at least the region of the heat treatment sheet 7 corresponding to the recess 34 is exposed to a laser beam. Thus, thermal energy generated from the light-to-heat conversion layer 4 of the heat treatment sheet 7 dries the functional liquid (conductive material layer) in the recess 34 (see FIG. 7). By repeating the series of the intermediate drying step and the foregoing deposition step, a plurality of layers constituted of droplets of the functional liquid are deposited to a thick wiring pattern (film pattern) 33A, as shown in FIG. 6(g).

Firing Step

The disperse medium in the film dried after the deposition step needs to be removed in order to ensure the electrical contact between the particles. In addition, if, for example, an organic coating is applied onto the surfaces of the conductive particles in order to enhance the dispersibility, the coating also needs to be removed. If the functional material contains an organic silver compound, it is necessary to heat-treat the functional liquid to remove the organic constituents from the organic silver compound and, thus, allow the silver particles to remain. For this reason, the substrate (object) 3 is subjected to the heat treatment according to an exemplary aspect of the present invention, after the deposition step. Specifically, the banks B and the wiring pattern 33A in the recess 34 on the substrate 3, or the object, are brought into close contact with the heat treatment sheet 7, and at least the region of the heat treatment sheet 7 corresponding to the recess 34 is exposed to a laser beam. Thus, thermal energy generated from the light-to-heat conversion layer 4 of the heat treatment sheet 7 fires the film pattern 33A in the recess 34 (see FIG. 7). Thus, the electrical contact between the particles of the conductive material (organic silver compound) is ensured, and functional liquid is converted to the conductive wiring pattern 33, as shown in FIG. 6(h).

The banks B on the substrate 3 can be removed by ashing removal after the firing step. For the ashing removal, plasma ashing, ozone ashing, and other treatment may be applied. In the plasma ashing, oxygen gas plasma or other gas plasma is allowed to react with the banks to vaporize, thereby removing the banks. The banks include a solid material constituted of carbon, oxygen, and hydrogen. These constituents react with oxygen plasma to CO₂, H₂O, and O₂ gases, thus vaporizing to be removed. The ozone ashing is based on the same fundamental principle as the plasma ashing. Specifically, O₃ (ozone) is decomposed into reactive O⁺ gas (oxygen radical), and the O⁺ is allowed to react with the banks. The banks react with the O⁺ to CO₂, H₂O, and O₂, thereby vaporizing to remove. By applying the ashing removal to the substrate 3, the banks are removed from the substrate 3.

In the present exemplary embodiment, the banks B are provided on the substrate 3 to partition a predetermined region, and the functional liquid is deposited in the region between the banks B. Alternatively, lyophobic regions and lyophilic regions are provided at the surface of the substrate 3, and the functional liquid is discharged onto the lyophilic regions from the discharge head 20. If the lyophobic regions and lyophilic regions are provided at the surface of the substrate 3, the substrate 3 is treated with, for example, FAS (fluoroalkylsilane) to be made lyophobic by self-organized deposition, chemical vapor deposition, or the like. Then, the substrate 3 is selectively exposed to ultraviolet (UV) light, and thus the lyophobic regions and the lyophilic regions are provided. For the lyophobic treatment, for example, plasma treatment (CF₄ plasma treatment) may be adopted in an atmosphere of air using tetrafluoromethane as a reaction gas.

Other fluorocarbon gases may be used as the reaction gas, instead of tetrafluoromethane (carbon tetrafluoride). In addition, treatment gases other than fluoride gases may be used if they can provide properties lyophobic to the functional liquid.

The functional liquid containing the wiring pattern forming material may be a disperse liquid of conductive particles dispersed in a disperse medium. The conductive particles include metal particles containing at least one of gold, silver, copper, aluminum, palladium, and nickel, oxides of these metals, conductive polymer particles, and superconductive particles. The disperse medium is not particularly limited as long as it can disperse the conductive particles and not flocculate the particles. Exemplary disperse media include water; alcohols, such as methanol, ethanol, propanol, and butanol; hydrocarbons, such as n-heptane, n-octane, decane, dodecane, tetradecane, toluene, xylene, cymene, durene, indene, dipentene, tetrahydronaphthalene, decahydronaphthalene, and cyclohexylbenzene; ethers, such as ethylene glycol dimethyl ether, ethylene glycol diethyl ether, ethylene glycol methylethyl ether, diethylene glycol dimethyl ether, diethylene glycol diethyl ether, diethylene glycol methylethyl ether, 1,2-dimethoxyethane, bis(2-methoxyethyl)ether, and p-dioxane; and polar compounds, such as propylene carbonate, y-butyrolactone, N-methyl-2-pyrrolidone, dimethylformamide, dimethyl sulfoxide, and cyclohexanone. Among these, preferred are water, alcohols, hydrocarbons, and ethers, and particularly water and hydrocarbons, from the viewpoint of dispersibility of the particles, stability of the disperse liquid, and ease of application to the liquid discharge technique.

Plasma Display Device

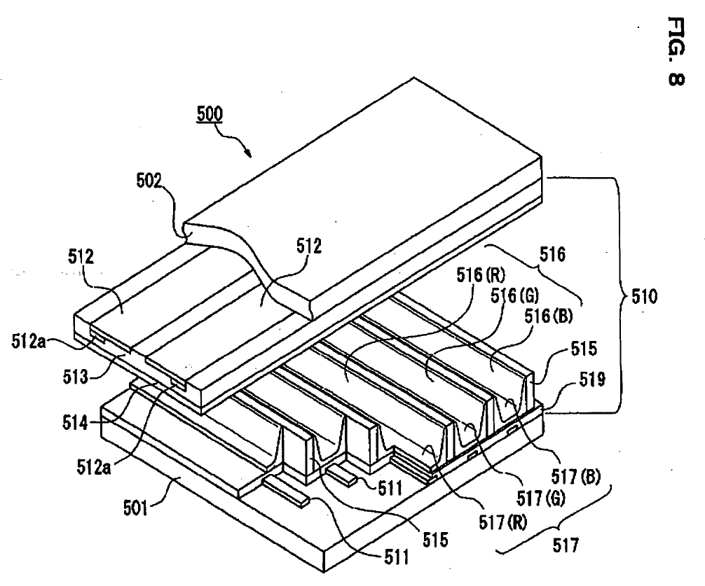

A plasma display device will now be described as an example of electro-optic devices including a wiring pattern formed by the wiring pattern forming method of an exemplary aspect the present invention, with reference to FIG. 8. FIG. 8 is a schematic of a plasma display 500 including address electrodes 511 and bus electrodes 512a. The plasma display 500 is essentially composed of glass substrates 501 and 502 opposed to each other and an electric discharge display portion 510 lying between the substrates 501 and 502.

The electric discharge display portion 510 includes a plurality of discharge compartments 516 which are arranged so that a pixel is composed of a red discharge compartment 516(R), a green discharge compartment 516(G), and a blue discharge compartment 516(B). The address electrodes 511 are disposed in a striped manner at predetermined intervals on the upper surface of the glass substrate 501. The address electrodes 511 and the upper surface of the substrate 501 are covered with a dielectric layer 519. On the dielectric layer 519, barrier walls 515 are provided each between the address electrodes 511, along the address electrodes 511. The barrier walls 515 are also provided perpendicular to the address electrodes 511 at predetermined intervals, in the positions in their longitudinal direction (but not shown in the figure). The barrier walls 515 at both sides of the address electrode 511 and the barrier walls 515 perpendicular to the address electrode 511 define a rectangular region. The discharge compartment 516 is formed corresponding to the rectangular region, and a group of three rectangular regions defines a pixel. The rectangular region partitioned by the barrier walls 515 is provided with a fluorescent layer 517 therein. The fluorescent layer 517 emits any one of fluorescent colors of red, green, and blue. The bottom of the red discharge compartment 516(R) is provided with a red fluorescent layer 517(R); the bottom of the green discharge compartment 516(G), a green fluorescent layer 517(G); the bottom of the blue discharge compartment 516(B), a blue fluorescent layer 517(B).

On the glass substrate 502 side, a plurality of ITO transparent display electrodes 512 extends in a stripped manner at predetermined intervals, in the direction perpendicular to the address electrodes 511, and metallic bus electrodes 512a are provided to help the high-resistance ITO electrodes. These electrodes are covered with a dielectric layer 513, and further with a protective layer 514 of, for example, MgO. The substrates 501 and the glass substrate 502 are bonded together in such a manner that the address electrodes 511 and the display electrodes 512 are opposed to each other at right angles. The rooms surrounded by the substrate 501, the barrier walls 515, and the protective layer 514 on the glass substrate 502 side are evacuated and filled with an inert gas to form discharge compartments 516. Each discharge compartment 516 has two of the display electrodes 512 provided on the glass substrate 502 side. The address electrodes 511 and the display electrodes 512 are connected to an alternator. By energizing the electrodes, the fluorescent layer 517 is excited to emit light in the electric discharge portion 510 in a desired position, thereby forming a color image.

In the present exemplary embodiment, the address electrodes 511 and the bus electrodes 512a are formed by the wiring pattern forming method of an exemplary aspect of the present invention. This method is advantageous particularly to pattern the address electrodes 511 and the bus electrodes 512a. Specifically, a functional liquid containing a metal colloid (for example, gold colloid or silver colloid) or a type of conductive particles (for example, metal particles) is discharged, and the discharged material is dried and fired. In addition, the fluorescent layer 517 can also be formed by discharging a functional liquid of the fluorescent material dissolved in a solvent or dispersed in a disperse medium from the discharge head 20, and subsequently drying and firing the material.

Color Filter

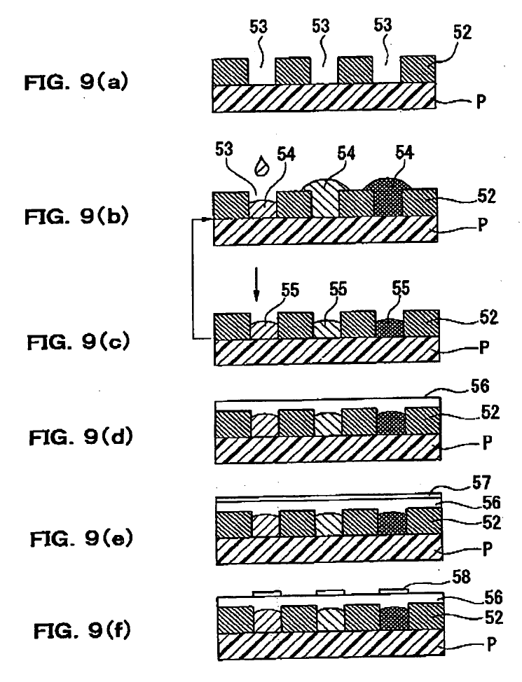

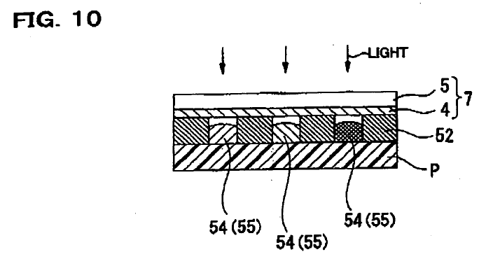

A procedure to form color filters of a liquid crystal display device, which is an example of the electro-optic device, will now be described with reference to FIGS. 9 and 10, and the heat treatment method of an exemplary aspect of the present invention is applied to this process. First, a black matrix (banks) 52 is formed on one surface of a transparent substrate P, as shown in FIG. 9(a). The black matrix 52 is intended to partition a color filter-forming region, and it is formed by, for example, photolithography.

Turning to FIG. 9(b), droplets of a functional liquid 54 containing a color filter material are discharged from the discharge head 20 to land onto filter elements 53. In this instance, a sufficient amount of the functional liquid 54 is discharged, in consideration of the decrease in volume resulting from the heating steps (drying and firing steps).

After filling all the filter elements 53 on the substrate P with the functional liquid 54, the functional liquid 54 is heated by the heat treatment method of an exemplary aspect of the present invention. Specifically, as shown in FIG. 10, the light-to-heat conversion layer 4 of the heat treatment sheet 7 is brought into close contact with the black matrix 52, and the heat treatment sheet 7 is exposed to light. The heat treatment causes the solvent of the functional liquid (functional material layer) containing color filter material to vaporize, thereby reducing the volume of the functional liquid. If the decrease in volume is large, a series of the discharge step and the heating step is repeated until the thickness becomes sufficient for a color filter. Thus, the solvent of the functional liquid is vaporized, and leaves only a solid content (functional material) of the functional liquid to form a film defining a color filter 55, as shown in FIG. 9(c).

Then, in order to planarize the substrate P and protect the color filters 55, a protective layer 56 is formed over the substrate P to cover the color filters 55 and the black matrix 52. The protective layer 56 is formed by spin coating, roll coating, ripping, or the like, and it may be formed by the same discharging as in the color filter 55. Turning to FIG. 9(e), a transparent conducting layer 57 is formed over the entire surface of the protective layer 56 by sputtering, vacuum deposition, or other deposition techniques. Then, the transparent conducting layer 57 is patterned to pixel electrodes 58 corresponding to the filter elements 53, as shown in FIG. 9(f). If the liquid crystal display panel is driven by TFTs (thin-film transistors), this patterning is not necessary. By using the discharge head 20 to form such color filters, the color filter material can be continuously discharged without a problem. Thus, superior color filters can be provided, and productivity can also be increased.

Organic EL Display Device

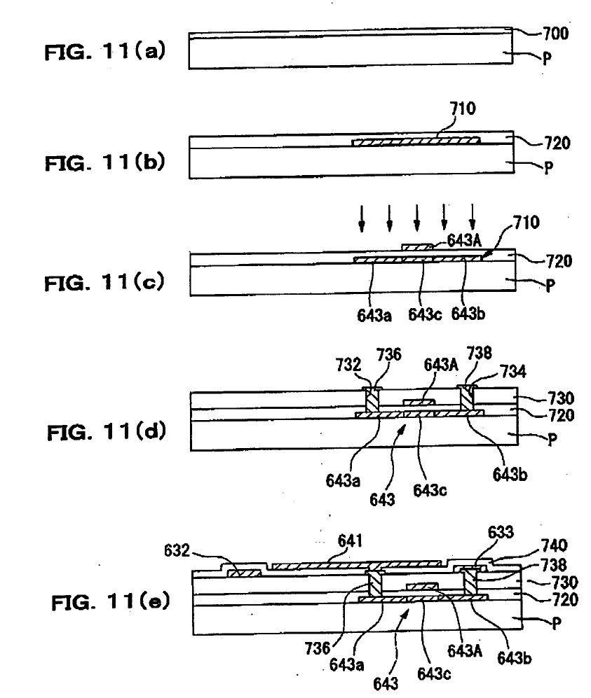

The heat treatment method of an exemplary aspect of the present invention can also be applied to the manufacture of an organic EL display, which is an example of the electro-optic device. The method to manufacture the organic EL display device will now be described with reference to FIGS. 11 to 13. FIGS. 11 to 13 show only a single pixel for simplifying the description.

First, a substrate P is prepared. In the resulting organic EL element of the present exemplary embodiment, light emitted from the luminescent layer may be drawn from the substrate side or the opposite side. If the emitted light is drawn from the substrate side, the substrate includes a transparent or translucent material, such as glass, quartz, or resin. In particular, glass is preferable because it is inexpensive. In the present exemplary embodiment, the substrate P is transparent, and includes, for example, glass, as shown in FIG. 11(a). A semiconductor layer 700 is formed of an amorphous silicon layer on the substrate P. Then, the semiconductor layer 700 is subjected to laser annealing or the heat treatment according to an exemplary aspect of the present invention to be crystallized into a polysilicon layer. For the crystallization, solid phase deposition may be applied. Then, the semiconductor layer (polysilicon layer) 700 is patterned to an island-shaped semiconductor layer 710. A gate insulating layer 720 is provided on the surface of the semiconductor layer 710, as shown in FIG. 11(b). Turning to FIG. 11(c), a gate electrode 643A is provided as shown in the figure. In this state, phosphorus ions are implanted at a high concentration and, thus, source/drain regions 643a and 643b are formed in the semiconductor layer 710 in a self-aligned manner with respect to the gate electrode 643A. The region where the dopant is not implanted is defined as a channel region 643c. Turning to FIG. 11(d), an insulating interlayer 730 having contact holes 732 and 734 is formed, and junction electrodes 736 and 738 are formed so as to fill the contact holes 723 and 724. Then, a signal line 632, a common power line 633, and a scanning line (not shown in FIG. 11) are formed on the insulating interlayer 730, as shown in FIG. 11(e). The junction electrode 738 and these lines may be formed in the same step.

In this instance, the other junction electrode 736 is formed of ITO, described later. Then, an insulating interlayer 740 is formed to cover the lines, and is provided with a contact hole (not shown in the figure) in a position corresponding to the junction electrode 736. An ITO layer is formed, filling the contact hole. The ITO layer is patterned to form a pixel electrode 641 electrically connected to the source or drain region 643a in a predetermined position surrounded by the signal line 632, the common power line 633, and the scanning line (not shown in the figure). A hole injection layer and a luminescent layer are to be formed in the region surrounded by the signal line 632, the common power line 633, and the scanning lines (not shown in the figure), as described later.

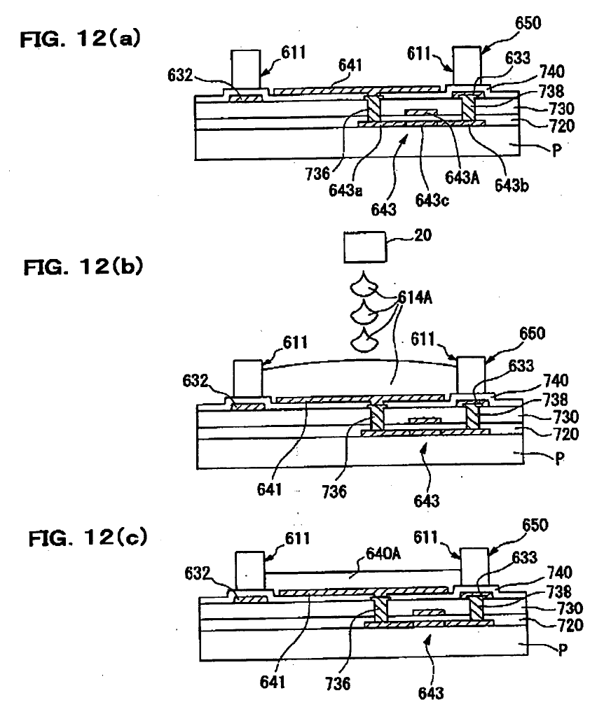

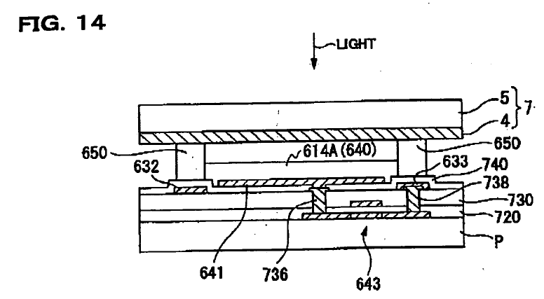

Turning to FIG. 12(a), banks 650 are provided so as to surround this region, as shown in the figure. The banks 650 serve as partitions, and are formed, for example, an insulative organic material, such as polyimide. Preferably, the banks 650 lack affinity for the functional liquid discharged from a liquid discharge head. In order for the banks 650 to have non-affinity, the surface of the banks 650 is, for example, surface-treated with a fluoride. Exemplary fluorides include CF₄, SF₅, and CHF₃. For the surface treatment, for example, plasma treatment or UV exposure treatment is performed. Thus, steps 611 are formed with a sufficient difference in height between the banks 650 and the region to form the hole injection layer and luminescent layer, the region where the materials of these layers are applied. Then, a functional liquid 614A containing a hole injection material is selectively discharged from the liquid discharge head 20 onto the region surrounded by the banks 650 or region inside the banks 650, with the upper surface of the substrate P upward, as shown in FIG. 12(b). The functional liquid 614A deposited on the substrate P is heat-treated (dried) by the heat treatment method of an exemplary aspect of the present invention. Specifically, as shown in FIG. 14, the heat treatment sheet 7 is brought into close contact with the banks 650, and the heat treatment sheet 7 is exposed to light. Thus, the solvent of the functional liquid (functional material layer) 614A is vaporized to form a solid hole injection layer 640A on the pixel electrode 641, as shown in FIG. 12(c).

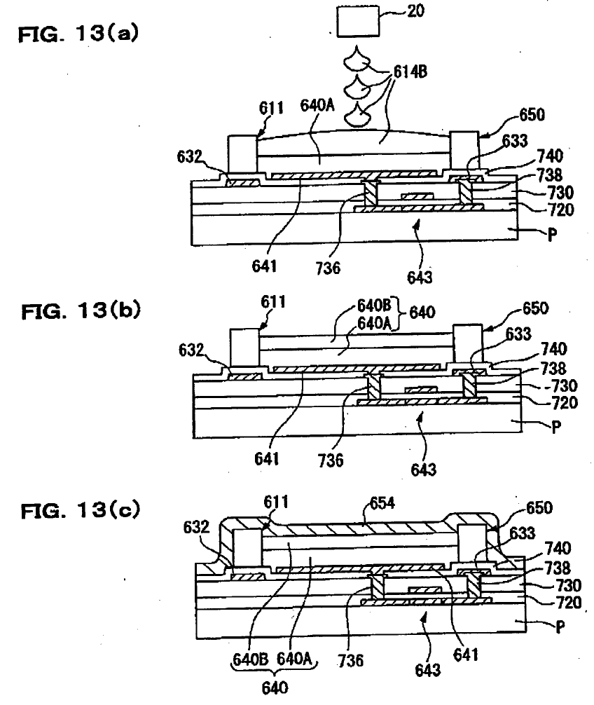

Then, a functional liquid 614B containing a luminescent layer material (luminescent material) is selectively discharged from the liquid discharge head 20 onto the hole injection layer 640A surrounded by the banks 650, with the upper surface of the substrate P upward, as shown in FIG. 13(a). By discharging the functional liquid 614B containing the luminescent layer material from the liquid discharge head, the functional liquid 614B is applied onto the hole injection layer 640A in the region surrounded by the banks 650. The functional liquid 614B contains any one of a red luminescent material, a green luminescent material, and a blue luminescent material. For the formation of the luminescent layer, these three types of the functional liquid are each discharged to the corresponding pixel and thus applied. The pixel arrangement is set in advance so that these colors are regularly arrayed. After being discharged and applied, each types of the functional liquid 614B are heat-treated (dried) to vaporize the solvent of the functional liquid 614B by the heat treatment method of an exemplary aspect of the present invention, thus forming the solid luminescent layer 640B on the hole injection layer 640A, as shown in FIG. 13(b). The hole injection layer 640A and the luminescent layer 640B define a light-emitting portion 640. Then, a reflection electrode 654 (opposing electrode) is formed over the entire surface of the transparent substrate P or in a striped manner, as shown in FIG. 13(c). Thus, an organic EL element is completed.

The pixel electrode may be reflective, and the opposing electrode may be transparent. In such a structure, luminescent light is emitted upward in the figure. In another structure, the pixel electrode may be transparent, and a reflective material is provided under the pixel electrode. The reflective material may includes aluminum (Al), and light is emitted upward in the figure, as in the above structure.

As described above, in the present exemplary embodiment, the hole injection layer 640A and the luminescent layer 640B are formed by the liquid discharge technique and the heat treatment method of an exemplary aspect of the present invention. Also, the signal line 632, the common power line 633, the scanning line, and the pixel electrode 641 are formed by the wiring patter forming method of an exemplary aspect of the present invention.

Electronic Apparatus

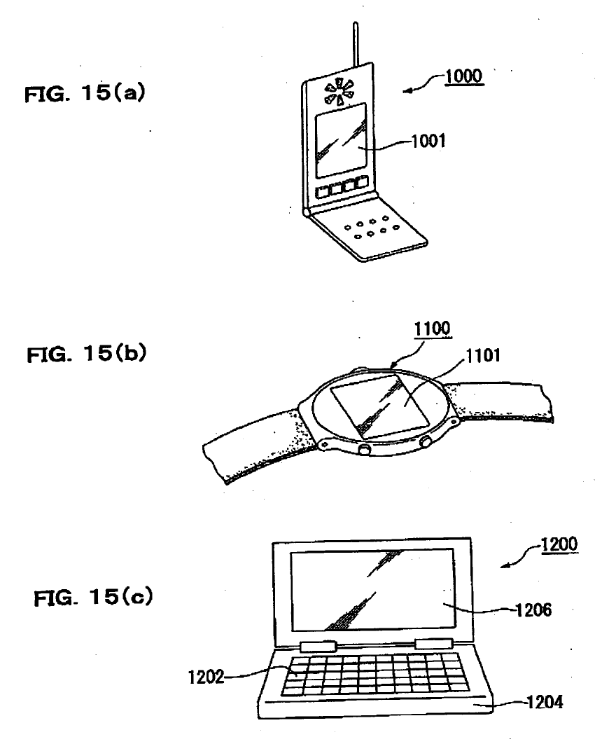

Applications of an electronic apparatus including the above-described electro-optic device (the organic EL display device, the plasma display device, the liquid crystal display device, or the like) will now be described. FIG. 15(a) is a schematic of a cellular phone. In FIG. 15(a), reference numeral 1000 represents the cellular phone proper, and reference numeral 1001 represents a display including the above-described electro-optic device. FIG. 15(b) is a schematic of a wrist watch type electronic apparatus. In FIG. 15(b), reference numeral 1100 represents the watch proper, and reference numeral 1101 represents a display including the above-described electro-optic device. FIG. 15(c) is a schematic of a portable information processing apparatus, such as a word processor or a personal computer. In FIG. 15(c), reference numeral 1200 represents the information processing apparatus, and reference numerals 1202, 1204, and 1206 represent an input portion, such as a keyboard, a body of the information processing apparatus, and a display including the above-described electro-optic device, respectively. Since the electronic apparatuses shown in FIGS. 15(a) to 15(c) include the electro-optic device according to the foregoing exemplary embodiments, the display can produce bright, high-quality images.

Other electronic apparatus include liquid crystal TV sets, viewfinder-type and monitor-direct-view-type video tape recorders, car navigation systems, pagers, electronic notebooks, electronic calculators, word processors, workstations, video phones, POS terminals, electronic papers, and apparatus include touch panel. The electro-optic device of an exemplary aspect of the present invention can be used as the display of these electronic apparatus.

Microlens

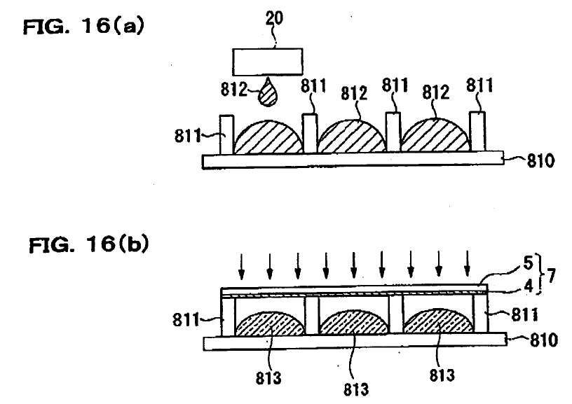

FIG. 16 shows a process to form microlenses by the heat treatment method of an exemplary aspect of the present invention.

As shown in FIG. 16(a), banks 811 are formed on a substrate 810. Then, a functional liquid 812 containing a lens material is discharged into the recesses between the banks 811 from the discharge head 20. The lens material may be transparent and has a high refractive index. For example, a photo-curable or thermosetting resin or an inorganic material is used. In the present exemplary embodiment, a thermosetting resin is used. The banks 811 may be subjected to lyophobic treatment before discharging the functional liquid 812. Turning to FIG. 16(b), the lens material 812 deposited on the substrate 810 is cured. For curing treatment, the heat treatment method of an exemplary aspect of the present invention is applied. Specifically, the heat treatment sheet 7 is brought into close contact with the banks 811, and the heat treatment sheet 7 is exposed to light. If the lens material is a photo-curable resin, the material is exposed to light having a predetermined wavelength to be cured. By the curing treatment, convex lenses 813 are formed in the regions defined by the banks 811.

1. A method of heat treatment, comprising:
heat-treating an object with a light-to-heat converting material to convert light energy into thermal energy, by exposing a base material having the light-to-heat converting material to light with the base material opposed to the object.

2. The method of heat treatment according to claim 1, the light being emitted to the base material with the object in close contact with the base material.

3. The method of heat treatment according to claim 1, a light-to-heat conversion layer containing the light-to-heat converting material being provided on the base material independently from the base material.

4. The method of heat treatment according to claim 3, the light being emitted to the base material with the object opposed to the light-to-heat conversion layer.

5. The method of heat treatment according to claim 3, the light being emitted to the base material with the object in close contact with the light-to-heat conversion layer.

6. The method of heat treatment according to claim 1, the base material containing the light-to-heat converting material.

7. The method of heat treatment according to claim 1, the heat treatment including at least one of drying and firing.

8. The method of heat treatment according to wherein claim 1, the object includes a conductive material to be heat-treated.

9. The method of heat treatment according to claim 1, the wavelength of the light being selected depending on the light-to-heat converting material.

10. A method to form a wiring pattern, comprising:
heat-treating a conductive material layer provided on an object by the method of heat treatment as set forth in claim 1.

11. A method to manufacture an electro-optic device, comprising:
heat-treating of a functional material layer provided on an object by the method of heat treatment as set forth in claim 1.

12. An electro-optic device, comprising:
a wiring pattern formed by the method as set forth in claim 10.

13. An electro-optic device manufactured by the method as set forth in claim 11.

14. An electronic apparatus, comprising:
the electro-optic device as set forth in claim 12.
